(19) United States
(12) Patent Application Publication
(10) Pub. No.: US 2013/0059110 A1
(43) Pub. Date: Mar. 7, 2013

(54) AGGREGATE OF FIBROUS COLUMNAR STRUCTURES AND ADHESIVE MEMBER

(71) Applicant: Youhei Maeno, Ibaraki-shi (JP)

(72) Inventor: Youhei Maeno, Ibaraki-shi (JP)

(73) Assignee: NITTO DENKO CORPORATION, Ibaraki-shi, Osaka (JP)

(21) Appl. No.: 13/698,081

(22) PCT Filed: Jun. 28, 2011
(86) PCT No.: PCT/JP2011/064779

§ 371 Date: Nov. 15, 2012

(30) Foreign Application Priority Data
Aug. 23, 2010 (JP) 2010-185813

(51) Int. Cl. C09J 9/00; B82Y 30/00

(52) U.S. Cl. 428/96; 977/832

(57) ABSTRACT

Provided is a fibrous columnar structure aggregate having a high shear adhesive strength. Also provided is a pressure-sensitive adhesive member using such fibrous columnar structure aggregate. The fibrous columnar structure aggregate is a fibrous columnar structure aggregate, including a plurality of fibrous columnar structures, in which the fibrous columnar structures each have a surface provided with a surface coating layer formed of a coating material having a Hamaker constant of 10×10⁻²⁰ J or more.

### TECHNICAL FIELD

The present invention relates to a fibrous columnar structure aggregate and a pressure-sensitive adhesive member, and more specifically, to a fibrous columnar structure aggregate and a pressure-sensitive adhesive member each having a high shear adhesive strength.

### BACKGROUND ART

Pressure-sensitive adhesives each having various properties have been used in industrial applications. However, materials for most of the adhesives are viscoelastic bodies each subjected to flexible bulk designing. Because of its low modulus, a pressure-sensitive adhesive formed of a viscoelastic body becomes wet to conform to an adherend, thereby expressing its adhesive strength.

Meanwhile, a fibrous columnar structure having a fine diameter as a novel pressure-sensitive adhesive has been known to show adhesive property. It has been elucidated that the structure follows surface unevenness of an adherend to express its adhesive strength by virtue of a van der Waals force because the structure has a diameter of the order of 10⁻⁶ m to 10⁻⁹ m.

Recently, a carbon nanotube as the fibrous columnar structure has been reported to exhibit pressure-sensitive adhesive property (see Patent Literature 1 and Patent Literature 2). It has been elucidated that the carbon nanotube follows the surface unevenness of the adherend to exert its adhesive strength by virtue of the van der Waals force because the carbon nanotube has a nanoscale diameter.

According to the description of Patent Literature 1, the carbon nanotube has a high adhesive strength per fiber, and provides an adhesive strength equivalent to that of a general-purpose pressure-sensitive adhesive in terms of adhesive strength per unit area. However, according to the description of Patent Literature 2, there is a problem in that, when adhesion evaluation is performed in an adhesion area of about 1 cm² in order to perform evaluation in a similar manner to that for the general-purpose pressure-sensitive adhesive, the carbon nanotube exhibits only a weak adhesive strength as compared to the general-purpose pressure-sensitive adhesive because its shear adhesive strength is low.

### CITATION LIST

### Patent Literature

[PTL 1] US 2004/0071870 A1
[PTL 2] US 2006/0068195 A1

### SUMMARY OF INVENTION

### Technical Problem

An object of the present invention is to provide a fibrous columnar structure aggregate having a high shear adhesive strength. Another object of the present invention is to provide a pressure-sensitive adhesive member using such fibrous columnar structure aggregate.

### Solution to Problem

A fibrous columnar structure aggregate of the present invention is a fibrous columnar structure aggregate, including a plurality of fibrous columnar structures, in which the fibrous columnar structures each have a surface provided with a surface coating layer formed of a coating material having a Hamaker constant of 10×10⁻²⁰ J or more.

In a preferred embodiment, the surface coating layer has a thickness of 0.5 nm or more.

In a preferred embodiment, the fibrous columnar structures each have a diameter of 2,000 nm or less.

In a preferred embodiment, the fibrous columnar structures each have an aspect ratio of 10 or more.

In a preferred embodiment, the coating material includes at least one kind selected from MgO, CaO, Te, SiO₂, Ag, AgI, CdS, BaSO₄, Al₂O₃, AgCl, AgBr, TiOs, Fe, Pb, C, Sn, SnO₂, Si, Cu, Ge, Ag, Au, Fe(OH)₃, Pt, and BN.

In a preferred embodiment, the fibrous columnar structures are aligned in a lengthwise direction.

In a preferred embodiment, the fibrous columnar structures include carbon nanotubes.

In a preferred embodiment, the fibrous columnar structure aggregate of the present invention further includes a backing, in which one end of each of the fibrous columnar structures is fixed to the backing.

In another embodiment of the present invention, there is provided a pressure-sensitive adhesive member. The pressure-sensitive adhesive member of the present invention includes the fibrous columnar structure aggregate of the present invention.

### Advantageous Effects of Invention

According to the present invention, it is possible to provide the fibrous columnar structure aggregate having a high shear adhesive strength. In particular, it is possible to provide a fibrous columnar structure aggregate having a sufficiently high shear adhesive strength even when adhesion evaluation is performed in an adhesion area of about 1 cm² in order to perform evaluation in a similar manner to that for a general-purpose pressure-sensitive adhesive. It is also possible to provide the pressure-sensitive adhesive member using such fibrous columnar structure aggregate.

The effects as described above can be expressed when, in a fibrous columnar structure aggregate including a plurality of fibrous columnar structures, the fibrous columnar structures each have a surface provided with a surface coating layer formed of a coating material having a Hamaker constant of 10×10⁻²⁰ J or more.

### BRIEF DESCRIPTION OF DRAWINGS

FIG. 1 A schematic sectional view of a fibrous columnar structure aggregate in a preferred embodiment of the present invention.

FIG. 2 A schematic sectional view of a fibrous columnar structure aggregate-producing apparatus in a preferred embodiment of the present invention.

### DESCRIPTION OF EMBODIMENTS

### <<Fibrous Columnar Structure Aggregate>>

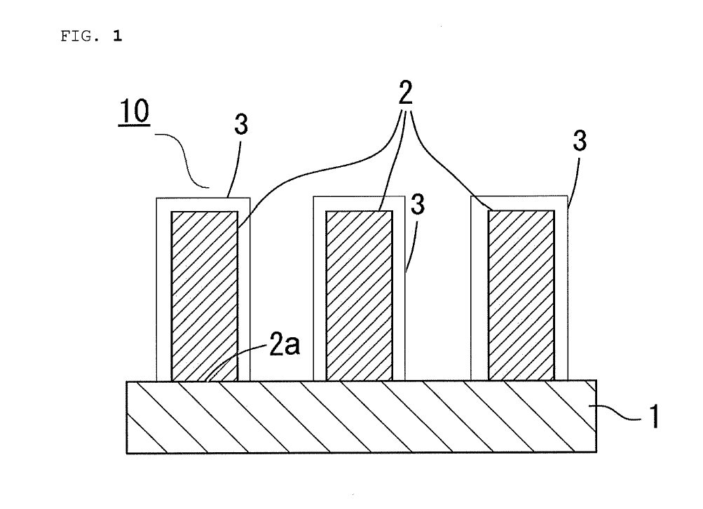

FIG. 1 illustrates a schematic sectional view of a fibrous columnar structure aggregate in a preferred embodiment of the present invention (the view is not precisely illustrated to scale in order that each constituent portion may be clearly illustrated).

A fibrous columnar structure aggregate 10 includes a backing 1 and a plurality of fibrous columnar structures 2. One end 2a of each of the fibrous columnar structures is fixed to the backing 1. The fibrous columnar structures 2 are aligned in a lengthwise direction L. The fibrous columnar structures 2 are preferably aligned in a direction substantially perpendicular to the backing 1.

The fibrous columnar structures 2 each have a surface provided with a surface coating layer 3 formed of a coating material having a Hamaker constant of 10×10²⁰ J or more.

It should be noted that, even in the case where the fibrous columnar structure aggregate includes no backing unlike the example illustrated in FIG. 1, the plurality of fibrous columnar structures may exist together as an aggregate by virtue of a van der Waals force, and hence the fibrous columnar structure aggregate of the present invention may be an aggregate including no backing.

The fibrous columnar structure aggregate of the present invention is a fibrous columnar structure aggregate including a plurality of fibrous columnar structures, in which the fibrous columnar structures each have a surface provided with a surface coating layer formed of a coating material having a Hamaker constant of 10×10⁻²⁰ J or more.

Any appropriate material may be adopted as a material for each of the fibrous columnar structures. Examples of the material include: metals such as aluminum and iron; inorganic materials such as silicon; carbon materials such as a carbon nanofiber and a carbon nanotube; and high-modulus resins such as an engineering plastic and a super engineering plastic. Specific examples of the resins include polystyrene, polyethylene, polypropylene, polyethylene terephthalate, acetylcellulose, polycarbonate, polyimide, and polyamide. Any appropriate physical property may be adopted as each of the various physical properties of any such resin such as a molecular weight as long as the objects of the present invention can be achieved.

The diameter of each of the fibrous columnar structures is preferably 0.3 nm to 2,000 nm, more preferably 1 nm to 1,000 nm, still more preferably 2 nm to 500 nm. When the diameter of each of the fibrous columnar structures falls within the range, the surface of each of the fibrous columnar structures can be appropriately provided with a surface coating layer having an appropriate thickness. As a result, a fibrous columnar structure aggregate having a high shear adhesive strength can be provided.

The aspect ratio of each of the fibrous columnar structures is preferably 10 or more, more preferably 100 or more, still more preferably 1,000 or more. The upper limit of the aspect ratio of each of the fibrous columnar structures is desirably as large as possible in order to express the effects of the present invention. However, when the actual production of the fibrous columnar structures is taken into consideration, the upper limit is preferably 10,000,000 or less, more preferably 1,000,000 or less. When the aspect ratio of each of the fibrous columnar structures falls within the range, the surface of each of the fibrous columnar structures can be appropriately provided with a surface coating layer having an appropriate thickness. As a result, a fibrous columnar structure aggregate having a high shear adhesive strength can be provided.

The length of each of the fibrous columnar structures may be set to any appropriate length. The length of each of the fibrous columnar structures is preferably 1 μm to 100,000 μm, more preferably 5 μm to 10,000 μm, still more preferably 10 μm to 1,000 μm. When the length of each of the fibrous columnar structures falls within the range, the surface of each of the fibrous columnar structures can be appropriately provided with a surface coating layer having an appropriate thickness. As a result, a fibrous columnar structure aggregate having a high shear adhesive strength can be provided.

The specific surface area and density of each of the fibrous columnar structures may be set to any appropriate values.

With regard to the shape of each of the fibrous columnar structures, the lateral section of the structure has only to have any appropriate shape. The lateral section is of, for example, a substantially circular shape, an elliptical shape, or an n-gonal shape (where n represents an integer of 3 or more). In addition, the fibrous columnar structures may be hollow, or may be filled materials.

The thickness of the surface coating layer is preferably 0.5 nm to 1,000 nm, more preferably 1 nm to 500 nm, still more preferably 5 nm to 100 nm. When the thickness of the surface coating layer falls within the range, a uniform surface coating layer can be provided and fusion between the fibrous columnar structures can be prevented. As a result, a fibrous columnar structure aggregate having a high shear adhesive strength can be provided.

The surface coating layer is formed of a coating material having a Hamaker constant of 10×10⁻²⁰ J or more. In this context, the Hamaker constant, which is also called a van der Waals constant, refers to a constant known as an aggregation-promoting factor. When the Hamaker constant of a given substance in a vacuum, the number of molecules in a unit area of a particle of the substance, and the London constant are represented by A, Q, and Λ, respectively, they have a relation as expressed by the equation A=π2Q2Λ. As a specific method of determining a Hamaker constant, there is given a method involving directly determining an attractive force between substances, a method involving calculation based on a critical aggregation concentration, a method involving determining a Hamaker constant based on measurement of a surface tension, and the like. The Hamaker constants of various substances are generally well known.

When the coating material for forming the surface coating layer has a Hamaker constant of 10×10⁻²⁰ J or more, a fibrous columnar structure aggregate having a high shear adhesive strength can be provided. In particular, a fibrous columnar structure aggregate having a sufficiently high shear adhesive strength even when adhesion evaluation is performed in an adhesion area of about 1 cm² in order to perform evaluation in a similar manner to that for a general-purpose pressure-sensitive adhesive can be provided.

In the present invention, it is important to select a coating material having a Hamaker constant of 10×10⁻²⁰ J or more.

Any appropriate material may be adopted as the coating material as long as the material has a Hamaker constant of 10×10⁻²⁰ J or more. Examples of such coating material include MgO, CaO, Te, SiO₂, Ag, AgI, CdS, BaSO₄, Al₂O₃, AgCl, AgBr, TiOs, Fe, Pb, C, Sn, SnO₂, Si, Cu, Ge, Ag, Au, Fe(OH)₃, Pt, and BN. The coating materials may be used alone or in combination.

In the fibrous columnar structure aggregate of the present invention, any appropriate intermediate layer may be provided between each of the fibrous columnar structures and the surface coating layer as long as the effects of the present invention are not impaired. The thickness of such intermediate layer is preferably 10 nm or less, more preferably 5 nm or less, still more preferably 3 nm or less. Examples of such intermediate layer include layers made of any appropriate metals and inorganic substances, preferably Cr.

The diameters and lengths of the fibrous columnar structures and the thickness of the surface coating layer have only to be measured with any appropriate apparatus. The measurement is preferably performed with a scanning electron microscope (SEM) or a transmission electron microscope (TEM). For example, at least ten, or preferably twenty or more, fibrous columnar structures out of the fibrous columnar structure aggregate have only to be evaluated for their diameters and lengths and the thickness of the surface coating layer by measurement with the SEM or TEM.

Any appropriate material may be adopted as the backing. Examples of the backing include: inorganic materials such as quartz glass and silicon (such as a silicon wafer); and resins such as a general-purpose resin, an engineering plastic, and a super engineering plastic. Specific examples of the resins include polyimide, polyethylene, polyethylene terephthalate, acetylcellulose, polycarbonate, polypropylene, and polyamide. Any appropriate physical property may be adopted as each of various physical properties such as a molecular weight of each of the resins as long as the objects of the present invention can be achieved.

The thickness of the backing may be set to any appropriate value depending on purposes. In the case of, for example, a silicon substrate, the thickness is preferably 100 to 10,000 μm, more preferably 100 to 5,000 μm, still more preferably 100 to 2,000 μm. In the case of, for example, a polypropylene substrate, the thickness is preferably 1 to 1,000 μm, more preferably 1 to 500 μm, still more preferably 5 to 100 μm.

The backing may be a single layer, or may be a multilayer body.

### <<Method of Producing Fibrous Columnar Structure Aggregate>>

Any appropriate method may be adopted as a method of producing the fibrous columnar structure aggregate of the present invention. The method of producing the fibrous columnar structure aggregate according to a preferred embodiment of the present invention is, for example, a method involving a step (I) of producing a fibrous columnar structure aggregate including a plurality of fibrous columnar structures and a step (II) of providing a surface coating layer on the surface of each of the fibrous columnar structures. Any one of the step (I) and the step (II) may be carried out first.

In the step (I), a fibrous columnar structure aggregate including a plurality of fibrous columnar structures is produced. As representative examples, the case where the fibrous columnar structures are each made of a resin such as polystyrene or polypropylene, and the case where the fibrous columnar structures are made of carbon nanotubes are described below.

When the fibrous columnar structures are each made of a resin such as polystyrene or polypropylene in the step (I), for example, the viscosity of the resin is decreased by heating or with a solution, and the resin is covered with a filter made of polycarbonate to fill the pores of the filter with the resin. Next, the filter is cooled to room temperature, or the solvent is removed, to form columnar structure portions in the pores of the filter. The filter is dissolved through immersion in methylene chloride to afford columnar structures.

When the fibrous columnar structures are made of carbon nanotubes in the step (I), the method is, for example, a method of producing a fibrous columnar structure aggregate aligned substantially perpendicularly from a smooth substrate by chemical vapor deposition (CVD) involving forming a catalyst layer on the substrate and filling a carbon source in a state in which a catalyst is activated with heat, plasma, or the like to grow the carbon nanotubes. In this case, removing the substrate provides a fibrous columnar structure aggregate aligned in a lengthwise direction.

Any appropriate substrate may be adopted as the substrate. The substrate is, for example, a material having smoothness and high-temperature heat resistance enough to resist the production of the carbon nanotubes. Examples of such material include quartz glass, silicon (such as a silicon wafer), and a metal plate made of, for example, aluminum.

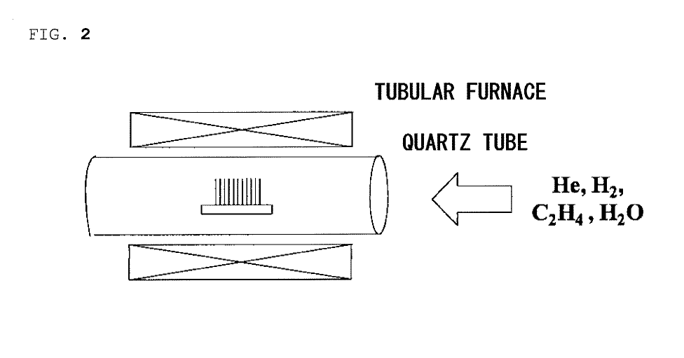

Any appropriate apparatus may be adopted as an apparatus for producing the fibrous columnar structure aggregate in which the fibrous columnar structures are made of carbon nanotubes. As a thermal CVD apparatus, there is given, for example, a hot wall type formed by surrounding a cylindrical reaction vessel with a resistance heating electric tubular furnace as illustrated in FIG. 2. In this case, for example, a heat-resistant quartz tube is preferably used as the reaction vessel.

Any appropriate catalyst may be used as the catalyst (material for the catalyst layer) that may be used in the production of the fibrous columnar structure aggregate in which the fibrous columnar structures are made of carbon nanotubes. Examples of the catalyst include metal catalysts such as iron, cobalt, nickel, gold, platinum, silver, and copper.

Upon production of the fibrous columnar structure aggregate in which the fibrous columnar structures are made of carbon nanotubes, an alumina/hydrophilic film may be provided between the substrate and the catalyst layer as required.

Any appropriate method may be adopted as a method of producing the alumina/hydrophilic film. For example, the film may be obtained by producing an SiO₂ film on the substrate, depositing Al from the vapor, and increasing the temperature of Al to 450° C. after the deposition to oxidize Al. According to such production method, Al₂O₃ interacts with the hydrophilic SiO₂ film, and hence an Al₂O₃ surface different from that obtained by directly depositing Al₂O₃ from the vapor in particle diameter is formed. When Al is deposited from the vapor, and then its temperature is increased to 450° C. so that Al may be oxidized without the production of any hydrophilic film on the substrate, it may be difficult to form the Al₂O₃ surface having a different particle diameter. In addition, when the hydrophilic film is produced on the substrate and Al₂O₃ is directly deposited from the vapor, it may also be difficult to form the Al₂O₃ surface having a different particle diameter.

The catalyst layer that may be used in the production of the fibrous columnar structure aggregate in which the fibrous columnar structures are made of carbon nanotubes has a thickness of preferably 0.01 to 20 nm, more preferably 0.1 to 10 nm in order that fine particles may be formed. When the thickness of the catalyst layer that may be used in the production of the fibrous columnar structure aggregate in which the fibrous columnar structures are made of carbon nanotubes falls within the range, the fibrous columnar structures can bring together excellent mechanical properties and a high specific surface area, and moreover, the fibrous columnar structures can be a fibrous columnar structure aggregate showing excellent pressure-sensitive adhesive property. Any appropriate method may be adopted as a method of forming the catalyst layer. Examples of the method include a method involving depositing a metal catalyst from the vapor, for example, with an electron beam (EB) or by sputtering and a method involving applying a suspension of metal catalyst fine particles onto the substrate.

Any appropriate carbon source may be used as the carbon source that may be used in the production of the fibrous columnar structure aggregate in which the fibrous columnar structures are made of carbon nanotubes. Examples of the carbon source include: hydrocarbons such as methane, ethylene, acetylene, and benzene; and alcohols such as methanol and ethanol.

Any appropriate temperature may be adopted as a production temperature in the production of the fibrous columnar structure aggregate in which the fibrous columnar structures are made of carbon nanotubes. For example, the temperature is preferably 400 to 1,000° C., more preferably 500 to 900° C., still more preferably 600 to 800° C. in order that catalyst particles allowing sufficient expression of the effects of the present invention may be formed.

In the step (II), a surface coating layer is provided on the surface of each of the fibrous columnar structures. Any appropriate method may be adopted as as a method of providing a surface coating layer on the surface of each of the fibrous columnar structures. Examples of the method include chemical vapor deposition and physical vapor deposition. Vacuum vapor deposition is preferred.

### <<Pressure-Sensitive Adhesive Member>>

A pressure-sensitive adhesive member of the present invention includes the fibrous columnar structure aggregate of the present invention. In the pressure-sensitive adhesive member of the present invention, it is preferred that the fibrous columnar structure aggregate of the present invention be provided with a backing. In the pressure-sensitive adhesive member of the present invention, it is more preferred that the fibrous columnar structure aggregate of the present invention be provided with a backing and one end of each of the fibrous columnar structures that construct the fibrous columnar structure aggregate be fixed to the backing.

Specifically, the pressure-sensitive adhesive member of the present invention is, for example, a pressure-sensitive adhesive sheet or a pressure-sensitive adhesive film.

Examples of the backing of the pressure-sensitive adhesive member include quartz glass, silicon (such as a silicon wafer), an engineering plastic, and a super engineering plastic. Specific examples of the engineering plastic and the super engineering plastic include polyimide, polyethylene, polyethylene terephthalate, acetylcellulose, polycarbonate, polypropylene, and polyamide. Any appropriate physical property may be adopted as each of various physical properties such as a molecular weight as long as the objects of the present invention can be achieved.

The thickness of the backing may be set to any appropriate value depending on purposes. In the case of, for example, a silicon substrate, the thickness is preferably 100 to 10,000 μm, more preferably 100 to 5,000 μm, still more preferably 100 to 2,000 μm. In the case of, for example, a polypropylene substrate, the thickness is preferably 1 to 1,000 μm, more preferably 1 to 500 μm, still more preferably 5 to 100 μm.

The surface of the backing may be subjected to a conventional surface treatment, e.g., a chemical or physical treatment such as a chromic acid treatment, exposure to ozone, exposure to a flame, exposure to a high-voltage electric shock, or an ionizing radiation treatment, or a coating treatment with an under coat (such as the above-mentioned adherent material) in order that adhesiveness with an adjacent layer, retentivity, or the like may be improved.

The backing may be a single layer, or may be a multilayer body.

When the fibrous columnar structure aggregate is fixed to the backing, any appropriate method may be adopted as a method of fixing the aggregate. For example, the substrate used in the production of the fibrous columnar structures may be used as it is as a backing. Alternatively, the aggregate may be fixed by providing the backing with an adhesion layer. Further, when the backing is a thermosetting resin, the aggregate has only to be fixed as described below. That is, a thin film is produced in a state before a reaction, one end of each fibrous columnar structure is crimped onto the thin film layer, and then a curing treatment is performed. In addition, when the backing is a thermoplastic resin, a metal, or the like, the aggregate has only to be fixed by crimping one end of each fibrous columnar structure in a state in which the backing is molten, and cooling the resultant to room temperature.

### EXAMPLES

Hereinafter, the present invention is described with reference to examples. However, the present invention is not limited to these examples.

### <Method of Measuring Shear Adhesive Strength>

A fibrous columnar structure aggregate cut out so as to have a unit area of 1 cm² was mounted on a glass (MATSUNAMI SLIDE GLASS, 27 mm×56 mm) coated with Au/Cr (coating thickness: 20 nm/1 nm) by sputtering so that its tip was brought into contact with the glass. Then, the tip of the fibrous columnar structure aggregate was crimped onto the glass by reciprocating a 5-kg roller once. After that, the resultant was left to stand for 30 minutes. A shearing test was performed with a tensile tester (Instron Tensile Tester) at a tension speed of 50 mm/min, and the resultant peak was defined as a shear adhesive strength.

### Example 1

### Fibrous Columnar Structure Aggregate in which Fibrous Columnar Structures are Made of Polystyrene

A polystyrene resin (manufactured by TCI, thickness: 30 μm) was heated on a hot plate to 200° C. to be melted. The molten polystyrene resin was covered with a filter made of polycarbonate (manufactured by Millipore, pore diameter: 0.2 μm) to fill the pores of the filter with a polystyrene resin. Next, the filter was cooled to room temperature to form columnar structure portions in the pores of the filter. The filter was dissolved through immersion in methylene chloride for 10 minutes to be removed from the backing. Thus, a fibrous columnar structure aggregate (1A) was obtained. The fibrous columnar structure aggregate (1A) had a diameter of 0.2 μm and a height of 20 μm.

Further, the surface of the fibrous columnar structure aggregate (1A) was coated with Au/Cr (coating thickness: 1 nm/1 nm) by sputtering to afford a fibrous columnar structure aggregate (1B) having a surface coating layer made of Au (Hamaker constant=45×10⁻²⁰ J) as an outermost layer.

The fibrous columnar structure aggregate (1B) was measured for its shear adhesive strength.

The results are summarized in Table 1.

### Example 2

### Fibrous Columnar Structure Aggregate in which Fibrous Columnar Structures are Made of Polystyrene

A fibrous columnar structure aggregate (2B) having a surface coating layer made of SiO₂ (Hamaker constant=15×10⁻²⁰J) as an outermost layer was obtained in the same manner as in Example 1 except that the surface of the fibrous columnar structure aggregate (1A) was coated with SiO₂ (coating thickness: 10 nm) by sputtering.

The fibrous columnar structure aggregate (2B) was measured for its shear adhesive strength.

The results are summarized in Table 1.

### Example 3

### Fibrous Columnar Structure Aggregate in which Fibrous Columnar Structures are Made of Polystyrene

A fibrous columnar structure aggregate (3B) having a surface coating layer made of Au (Hamaker constant=45×10⁻²⁰ J) as an outermost layer was obtained in the same manner as in Example 1 except that the surface of the fibrous columnar structure aggregate (1A) was coated with Au/Cr (coating thickness: 10 nm/1 nm) by sputtering.

The fibrous columnar structure aggregate (3B) was measured for its shear adhesive strength.

The results are summarized in Table 1.

### Example 4

### Fibrous Columnar Structure Aggregate in which Fibrous Columnar Structures are Made of Polypropylene

A polypropylene resin (manufactured by KYOKUYO PULP & PAPER CO., LTD., thickness: 30 μm) was heated on a hot plate to 200° C. to be melted. The molten polypropylene resin was covered with a filter made of polycarbonate (manufactured by Millipore, pore diameter: 2 μm) to fill the pores of the filter with the polypropylene resin. Next, the filter was cooled to room temperature to form columnar structure portions in the pores of the filter. The filter was dissolved through immersion in methylene chloride for 10 minutes to be removed from the backing. Thus, a fibrous columnar structure aggregate (4A) was obtained. The fibrous columnar structure aggregate (4A) had a diameter of 2 μm and a height of 18 μm.

Further, the surface of the fibrous columnar structure aggregate (4A) was coated with Au/Cr (coating thickness: 10 nm/1 nm) by sputtering to afford a fibrous columnar structure aggregate (4B) having a surface coating layer made of Au (Hamaker constant=45×10⁻²⁰ J) as an outermost layer.

The fibrous columnar structure aggregate (4B) was measured for its shear adhesive strength.

The results are summarized in Table 1.

### Example 5

### Fibrous Columnar Structure Aggregate in which Fibrous Columnar Structures are Made of Carbon Nanotubes

An Fe/Al₂O₃ thin film (1 nm/10 nm) was formed on a silicon substrate (manufactured by ELECTRONICS AND MATERIALS CORPORATION, thickness: 525 μm) by sputtering. After that, the silicon wafer with a catalyst was cut and placed in a 30-mmφ quartz tube, and a helium/hydrogen (120/80 sccm) mixed gas kept at a moisture content of 350 ppm was flowed through the quartz tube for 30 minutes to replace the inside of the tube. After that, the temperature was gradually increased with a tubular electric furnace to 765° C. in 35 minutes and stabilized at 765° C. The inside of the tube was filled with a helium/hydrogen/ethylene (105/80/15 sccm, moisture content: 350 ppm) mixed gas and the tube was left to stand for 35 minutes to allow carbon nanotubes to grow. The resultant fibrous columnar structure aggregate (5A) had a length of 600 μm, in which the wall number peaked at 2 with a ratio of 69%.

Further, the surface of the fibrous columnar structure aggregate (5A) was coated with Au/Cr (coating thickness: 1 nm/1 nm) by sputtering to afford a fibrous columnar structure aggregate (5B) having a surface coating layer made of Au (Hamaker constant=45×10⁻²⁰ J) as an outermost layer.

A polypropylene resin (manufactured by KYOKUYO PULP & PAPER CO., LTD., thickness: 30 μm) was heated on a hot plate to 200° C. to be melted. One end (upper end) of the fibrous columnar structure aggregate (5B) was crimped onto the molten polypropylene resin, and the whole was then cooled to room temperature for fixation. Thus, a fibrous columnar structure aggregate (5C) with a polypropylene backing was obtained.

The fibrous columnar structure aggregate (5C) was measured for its shear adhesive strength.

The results are summarized in Table 1.

### Example 6

### Fibrous Columnar Structure Aggregate in which Fibrous Columnar Structures are Made of Carbon Nanotubes

A fibrous columnar structure aggregate (6B) having a surface coating layer made of SiO₂ (Hamaker constant=15×10⁻²⁰ J) as an outermost layer and a fibrous columnar structure aggregate (6C) with a polypropylene backing were obtained in the same manner as in Example 5 except that the surface of the fibrous columnar structure aggregate (5A) was coated with SiO₂ (coating thickness: 10 nm) by sputtering.

The fibrous columnar structure aggregate (6C) was measured for its shear adhesive strength.

The results are summarized in Table 1.

### Example 7

### Fibrous Columnar Structure Aggregate in which Fibrous Columnar Structures are Made of Carbon Nanotubes

A fibrous columnar structure aggregate (7B) having a surface coating layer made of Au (Hamaker constant=45×10⁻²⁰ J) as an outermost layer and a fibrous columnar structure aggregate (7C) with a polypropylene backing were obtained in the same manner as in Example 5 except that the surface of the fibrous columnar structure aggregate (5A) was coated with Au/Cr (coating thickness: 10 nm/1 nm) by sputtering.

The fibrous columnar structure aggregate (7C) was measured for its shear adhesive strength.

The results are summarized in Table 1.

### Example 8

### Fibrous Columnar Structure Aggregate in which Fibrous Columnar Structures are Made of Carbon Nanotubes

An Fe/Al₂O₃ thin film (2 nm/10 nm) was formed on a silicon substrate (manufactured by ELECTRONICS AND MATERIALS CORPORATION, thickness: 525 μm) by sputtering. After that, the silicon wafer with a catalyst was cut and placed in a 30-mmφ quartz tube, and a helium/hydrogen (120/80 sccm) mixed gas kept at a moisture content of 350 ppm was flowed through the quartz tube for 30 minutes to replace the inside of the tube. After that, the temperature was gradually increased with a tubular electric furnace to 765° C. in 35 minutes and stabilized at 765° C. The inside of the tube was filled with a helium/hydrogen/acetylene (105/80/15 sccm, moisture content: 350 ppm) mixed gas and the tube was left to stand for 30 minutes to allow carbon nanotubes to grow. The resultant fibrous columnar structure aggregate (8A) had a length of 600 μm, in which the wall number peaked at 7 with a ratio of 61.7%.

Further, the surface of the fibrous columnar structure aggregate (8A) was coated with Au/Cr (coating thickness: 1 nm/1 nm) by sputtering to afford a fibrous columnar structure aggregate (8B) having a surface coating layer made of Au (Hamaker constant=45×10⁻²⁰ J) as an outermost layer.

A polypropylene resin (manufactured by KYOKUYO PULP & PAPER CO., LTD., thickness: 30 μm) was heated on a hot plate to 200° C. to be melted. One end (upper end) of the fibrous columnar structure aggregate (8B) was crimped onto the molten polypropylene resin, and the whole was then cooled to room temperature for fixation. Thus, a fibrous columnar structure aggregate (8C) with a polypropylene backing was obtained.

The fibrous columnar structure aggregate (8C) was measured for its shear adhesive strength.

The results are summarized in Table 1.

### Example 9

### Fibrous Columnar Structure Aggregate in which Fibrous Columnar Structures are Made of Carbon Nanotubes

A fibrous columnar structure aggregate (9B) having a surface coating layer made of SiO₂ (Hamaker constant=15×10²⁰ J) as an outermost layer and a fibrous columnar structure aggregate (9C) with a polypropylene backing were obtained in the same manner as in Example 8 except that the surface of the fibrous columnar structure aggregate (8A) was coated with SiO₂ (coating thickness: 10 nm) by sputtering.

The fibrous columnar structure aggregate (9C) was measured for its shear adhesive strength.

The results are summarized in Table 1.

### Example 10

### Fibrous Columnar Structure Aggregate in which Fibrous Columnar Structures are Made of Carbon Nanotubes

A fibrous columnar structure aggregate (10B) having a surface coating layer made of Au (Hamaker constant=45×10⁻²⁰ J) as an outermost layer and a fibrous columnar structure aggregate (10C) with a polypropylene backing were obtained in the same manner as in Example 8 except that the surface of the fibrous columnar structure aggregate (8A) was coated with Au/Cr (coating thickness: 10 nm/1 nm) by sputtering.

The fibrous columnar structure aggregate (10C) was measured for its shear adhesive strength.

The results are summarized in Table 1.

### Comparative Example 1

### Fibrous Columnar Structure Aggregate in which Fibrous Columnar Structures are Made of Polystyrene

A fibrous columnar structure aggregate (C1B) having no surface coating layer was obtained in the same manner as in Example 1 except that the surface of the fibrous columnar structure aggregate (1A) was not coated with any material.

The fibrous columnar structure aggregate (C1B) was measured for its shear adhesive strength.

The results are summarized in Table 1.

### Comparative Example 2

### Fibrous Columnar Structure Aggregate in which Fibrous Columnar Structures are Made of Polystyrene

A fibrous columnar structure aggregate (C2B) having a surface coating layer made of KBr (Hamaker constant=7.16×10⁻²⁰ J) as an outermost layer was obtained in the same manner as in Example 1 except that the surface of the fibrous columnar structure aggregate (1A) was coated with KBr (coating thickness: 10 nm) by sputtering.

The fibrous columnar structure aggregate (C2B) was measured for its shear adhesive strength.

The results are summarized in Table 1.

### Comparative Example 3

### Fibrous Columnar Structure Aggregate in which Fibrous Columnar Structures are Made of Polypropylene

A fibrous columnar structure aggregate (C3B) having no surface coating layer was obtained in the same manner as in Example 4 except that the surface of the fibrous columnar structure aggregate (4A) was not coated with any material.

The fibrous columnar structure aggregate (C3B) was measured for its shear adhesive strength.

The results are summarized in Table 1.

### Comparative Example 4

### Fibrous Columnar Structure Aggregate in which Fibrous Columnar Structures are Made of Carbon Nanotubes

A fibrous columnar structure aggregate (C4B) having no surface coating layer and a fibrous columnar structure aggregate (C4C) with a polypropylene backing were obtained in the same manner as in Example 5 except that the surface of the fibrous columnar structure aggregate (5A) was not coated with any material.

The fibrous columnar structure aggregate (C4C) was measured for its shear adhesive strength.

The results are summarized in Table 1.

### Comparative Example 5

### Fibrous Columnar Structure Aggregate in which Fibrous Columnar Structures are Made of Carbon Nanotubes

A fibrous columnar structure aggregate (C5B) having a surface coating layer made of KBr (Hamaker constant=7.16×10⁻²⁰ J) as an outermost layer and a fibrous columnar structure aggregate (C5C) with a polypropylene backing were obtained in the same manner as in Example 5 except that the surface of the fibrous columnar structure aggregate (5A) was coated with KBr (coating thickness: 10 nm) by sputtering.

The fibrous columnar structure aggregate (C5C) was measured for its shear adhesive strength.

The results are summarized in Table 1.

### Comparative Example 6

### Fibrous Columnar Structure Aggregate in which Fibrous Columnar Structures are Made of Carbon Nanotubes

A fibrous columnar structure aggregate (C6B) having no surface coating layer and a fibrous columnar structure aggregate (C6C) with a polypropylene backing were obtained in the same manner as in Example 8 except that the surface of the fibrous columnar structure aggregate (8A) was not coated with any material.

The fibrous columnar structure aggregate (C6C) was measured for its shear adhesive strength.

The results are summarized in Table 1.

### Comparative Example 7

### Fibrous Columnar Structure Aggregate in which Fibrous Columnar Structures are Made of Carbon Nanotubes

A fibrous columnar structure aggregate (C7B) having a surface coating layer made of KBr (Hamaker constant=7.16×10⁻²⁰ J) as an outermost layer and a fibrous columnar structure aggregate (C7C) with a polypropylene backing were obtained in the same manner as in Example 8 except that the surface of the fibrous columnar structure aggregate (8A) was coated with KBr (coating thickness: 10 nm) by sputtering.

The fibrous columnar structure aggregate (C7C) was measured for its shear adhesive strength.

The results are summarized in Table 1.

TABLE 1

| | | | | | | | | | | | Shear |
|---|---|---|---|---|---|---|---|---|---|---|---|
| | | | | | | Aspect | Surface | Hamaker | Surface coating | | adhesive |
| | Fiber | Diameter | | Height | | ratio | coating | constant | thickness | | strength |
| Example 1 | St | 0.2 | μm | 20 | μm | 100 | Au | 45 | 1 | nm | 1.4 |
| Example 2 | St | 0.2 | μm | 20 | μm | 100 | SiO₂ | 15 | 10 | nm | 3.1 |
| Example 3 | St | 0.2 | μm | 20 | μm | 100 | Au | 45 | 10 | nm | 5.5 |
| Example 4 | PP | 2 | μm | 18 | μm | 9 | Au | 45 | 10 | nm | 1.5 |
| Example 5 | CNT | 5 | nm | 600 | μm | 120,000 | Au | 45 | 1 | nm | 30.0 |
| Example 6 | CNT | 5 | nm | 600 | μm | 120,000 | SiO₂ | 15 | 10 | nm | 36.2 |
| Example 7 | CNT | 5 | nm | 600 | μm | 120,000 | Au | 45 | 10 | nm | 48.8 |
| Example 8 | CNT | 20 | nm | 600 | μm | 30,000 | Au | 45 | 1 | nm | 34.9 |
| Example 9 | CNT | 20 | nm | 600 | μm | 30,000 | SiO₂ | 15 | 10 | nm | 42.1 |
| Example 10 | CNT | 20 | nm | 600 | μm | 30,000 | Au | 45 | 10 | nm | 50.8 |
| Comparative Example 1 | St | 0.2 | μm | 20 | μm | 100 | — | — | — | | 0.2 |
| Comparative Example 2 | St | 0.2 | μm | 20 | μm | 100 | KBr | 7.16 | 10 | nm | 0.3 |
| Comparative Example 3 | PP | 2 | μm | 18 | μm | 9 | — | — | — | | 0.1 |
| Comparative Example 4 | CNT | 5 | nm | 600 | μm | 120,000 | — | — | — | | 25.5 |
| Comparative Example 5 | CNT | 5 | nm | 600 | μm | 120,000 | KBr | 7.16 | 10 | nm | 26.3 |
| Comparative Example 6 | CNT | 20 | nm | 600 | μm | 30,000 | — | — | — | | 29.4 |
| Comparative Example 7 | CNT | 20 | nm | 600 | μm | 30,000 | KBr | 7.16 | 10 | nm | 28.6 |

St: Polystyrene, PP: Polypropylene, CNT: Carbon nanotube

As apparent from Table 1, when a surface coating layer formed of a coating material having a Hamaker constant of 10×10⁻²⁰ J or more was provided on the surface of each of the fibrous columnar structures, the shear adhesive strength remarkably improved.

### INDUSTRIAL APPLICABILITY

The fibrous columnar structure aggregate of the present invention can be suitably used as a pressure-sensitive adhesive because the aggregate has excellent pressure-sensitive adhesive property.

### REFERENCE SIGNS LIST

1 backing
2 fibrous columnar structure
2a one end of fibrous columnar structure
3 surface coating layer
10 fibrous columnar structure aggregate

1. A fibrous columnar structure aggregate, comprising a plurality of fibrous columnar structures, wherein
the fibrous columnar structures each have a surface provided with a surface coating layer formed of a coating material having a Hamaker constant of 10×10⁻²⁰ J or more.

2. A fibrous columnar structure aggregate according to claim 1, wherein the surface coating layer has a thickness of 0.5 nm or more.

3. A fibrous columnar structure aggregate according to claim 1, wherein the fibrous columnar structures each have a diameter of 2,000 nm or less.

4. A fibrous columnar structure aggregate according to claim 1, wherein the fibrous columnar structures each have an aspect ratio of 10 or more.

5. A fibrous columnar structure aggregate according to claim 1, wherein the coating material comprises at least one kind selected from MgO, CaO, Te, SiO₂, Ag, AgI, CdS, BaSO₄, Al₂O₃, AgCl, AgBr, TiOs, Fe, Pb, C, Sn, SnO₂, Si, Cu, Ge, Ag, Au, Fe(OH)₃, Pt, and BN.

6. A fibrous columnar structure aggregate according to claim 1, wherein the fibrous columnar structures are aligned in a lengthwise direction.

7. A fibrous columnar structure aggregate according to claim 1, wherein the fibrous columnar structures comprise carbon nanotubes.

8. A fibrous columnar structure aggregate according to claim 1, further comprising a backing, wherein one end of each of the fibrous columnar structures is fixed to the backing.

9. A pressure-sensitive adhesive member, comprising the fibrous columnar structure aggregate according to claim 1.
